(19) United States
(12) Patent Application Publication
(10) Pub. No.: US 2009/0153926 A1
(43) Pub. Date: Jun. 18, 2009

(54) Hologram Imaging Techniques And Holograms

(75) Inventors: John David Wiltshire, Copford (GB); David Roy Winterbottom, Colchester Esser (GB); Jonathan Fitt, Cambridgeshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: VER-TEC SECURITY SYSTEMS LIMITED, Cambridge, Cambridgeshire (GB)

(21) Appl. No.: 11/814,471

(22) PCT Filed: Jan. 23, 2006
(86) PCT No.: PCT/GB2006/050018

§ 371 Date: Feb. 23, 2009

Related U.S. Application Data
(60) Provisional application No. 60/651,650, filed on Feb. 11, 2005.

(30) Foreign Application Priority Data
Jan. 21, 2005 (GB) 0501215.8

(51) Int. Cl. G03H 1/22; G03H 1/26; G06K 19/16; G03H 1/02

(52) U.S. Cl. 359/2; 359/32; 359/22; 235/487

(57) ABSTRACT

This invention relates to improved techniques for reading holograms, in particular volume reflection holograms, and to improved security documents incorporating volume reflection holograms.

A method of imaging a volume reflection hologram on a surface, said surface bearing said volume reflection hologram and printing, said hologram and said printing being at least partially co-incident, the method comprising: illuminating said surface at a first angle, said first angle being selected such that a first image stored in said volume reflection hologram is replayed; capturing a first image of said illuminated surface, said first image comprising an image of said printing and of said first stored image; illuminating said surface at a second angle, said second angle being selected such that substantially no image is replayed by said volume reflection hologram; capturing a second image of said illuminated surface, said second image comprising an image of said printing substantially without an image stored in said hologram; and generating, an image of said first image stored in said hologram from said first captured image and said second captured image.

This invention relates to improved techniques for reading holograms, in particular volume reflection holograms, and to improved security documents incorporating volume reflection holograms.

Holograms are well known as security devices and are used as an anti-counterfeiting device on security documents such as passports, visas, identity cards, driving licenses, government bonds. Bills of Exchange, bank notes and the like as well as on packaging and labelling. Generally embossed holograms are used as these are suitable for mass manufacture. Variants of embossed holograms include Kinegrams (Trade Mark) in which graphic elements appear and disappear with viewing angle, and Pixelgrams (Trade Mark) in which image contrast/brightness varies with viewing angle. It will be appreciated, however, that there is scope for improved holographic techniques for increased security, and some of these techniques, in particular employing biometrics, are described in the applicant's co-pending PCT Application No. GB 2004/050014 hereby incorporated by reference.

Here we describe improved techniques which employ a combination of print and volume reflection holography. Broadly speaking a reflection hologram is a hologram which is constructed by interfering object and reference beams which are directed onto a recording medium from opposite sides of the medium; a volume hologram is a hologram in which the angle difference between the object and reference beams is equal to or greater than 90 degrees. Volume holograms are sometimes referred to as “thick” holograms since, roughly speaking, the fringes are in planes approximately parallel to the surface of the hologram, although in practice the thickness of the recording medium can vary significantly, say between 1 μm and 100 μm, typically around 7 μm. The techniques described herein are suitable for use with any conventional holographic recording medium including, but not limited to, dichromated gelatine (DCG), silver halide, and photo-polymer based recording media.

Volume holograms have special security advantages because they are particularly difficult to copy although they are not well suited to mass production. One property of volume holograms which is employed in the techniques described herein, is that an image replayed by a volume hologram has a well-defined colour—that is when illuminated from a broadband source (or at the correct wavelength) it will reflect over only a narrow wavelength band the full width at half maximum of the peak depends upon the thickness of the recording medium, a thicker medium resulting in a narrower peak. Thus an image replayed by a volume hologram has a specific spectral colour; however more than one image may be stored and replayed and these different images may have different colours. To replay a stored image the angle of incident illumination must be approximately correct; if the hologram is tilted away from this correct angle the diffraction efficiency falls off rapidly (although the colour of the replayed image generally remains substantially the same).

Background prior art may be found in the following documents:

US2003/134105; which describes a volume hologram multilayer structure, which is stuck over a photograph; U.S. Pat. No. 5,396,559, which describes the use of a dot pattern (as a form of sophisticated Moire fringe) recorded in a photograph or hologram; U.S. Pat. No. 4,563,024, which describes use of a photograph which identifies the owner or user of a device; EP 0 869 408A, which is similar to US2003/0134105 in that the personalised image in this device is a photograph and the hologram is merely used to protect this image; U.S. Pat. No. 5,986,746, which describes a fingerprint scanner using a hologram (but the hologram is not used for recording the fingerprint); GB 2313944A; EP 0010611A; U.S. Pat. No. 5,862,247; U.S. Pat. No. 5,815,598; U.S. Pat. No. 5,095,194; U.S. Pat. No. 3,704,949; U.S. Pat. No. 4,532,508; JP 63201795; JP 7096693A; DE197 13 218A.

Here we describe techniques which exploit the above described properties of volume holograms.

According to a first aspect of the invention there is therefore provided a method of imaging a volume reflection hologram on a surface, said surface bearing said volume reflection hologram and printing, said hologram and said printing being at least partially co-incident, the method comprising: illuminating said surface at a first angle, said first angle being selected such that a first image stored in said volume reflection hologram is replayed; capturing a first image of said illuminated surface, said first image comprising an image of said printing and of said first stored image; illuminating said surface at a second angle, said second angle being selected such that substantially no image is replayed by said volume reflection hologram; capturing a second image, of said illuminated surface, said second image comprising an image of said printing substantially without an image stored in said hologram; and generating an image of said first image stored in said hologram from said first captured image and said second captured image.

Preferably the illuminating at the first angle comprises illuminating at a first wavelength selected to replay the first stored image from the volume hologram, and the illuminating at the second angle comprises at one (or more) second wavelengths selected to inhibit replay of the first stored image by the hologram. Preferably the first and second angles of illumination make substantially the same angle with a normal to the illuminated surface, and preferably the two directions of illumination are opposite, that is substantially oppositely disposed about the normal to the surface, so that the first and second images are captured under similar surface illumination conditions. Preferably the first and second images are captured by an image capture device such as a colour or monochrome camera which is configured to image substantially normal to the surface.

Optionally the method may further comprise illuminating the surface at a third angle selected to replay a second image stored in a hologram, capturing a corresponding third image, and generating art image of the second image stored in the hologram from the captured first and third images. Preferably illuminating at the third angle comprises illuminating at a third wavelength selected to replay the second stored image.

The illuminating may comprise illuminating with a conventional filtered illumination source such as a filtered incandescent bulb, or illumination using a substantially monochromatic light source such as a light emitting diode, laser or laser diode. For example a bi-coloured LED (the colour selectable depending upon the polarity of applied voltage) may be conveniently deployed to illuminate at two different wavelengths, one corresponding to an image for replay by the hologram. The wavelength at which a stored image is replayed is determined by the wavelength of light used to fabricate the hologram but may, if desired, be varied by subsequent physical and/or chemical processing of the hologram.

Illuminating the hologram-bearing surface using the light of two different wavelengths or colours is particularly useful and effective for separating an image replayed by the volume reflection hologram from underlying text and/or graphic material viewable through the hologram. This is particularly the case when substantially pure, that is single-wavelength illumination is employed since under these circumstances the hologram image is significantly brighter than the underlying print.

The process of generating an image of the hologram from the captured images need not be perfect, depending upon the use to which the hologram is to be put. For example if the image of the hologram is to be matched against another, reference image for comparison and/or validation purposes some residual artifacts of the print image may still be present without significantly interfering with the comparison/matching process. The degree of separation achievable between the replayed holographic and print images depends, in part, upon the optical system—the illumination employed, the dynamic range of the image capture device and the like. Typically an image comprising of a combination of a replayed holographic image over print is not a linear summation of the two images at the points of overlap and thus, in embodiments, more than simple subtraction of the print image from the combined image may be necessary. In such circumstances a non-linear operation as a threshold operation may be employed to assist in the separation of the replayed holographic image from the underlying (or overlying) print. The person skilled in image processing will understand that a range of different techniques may be employed to facilitate separation of the holographic image from the combined image, for example including, but not limited to, 2D lowpass, bandpass or band reject filtering, 2D (discrete) fourier transformation, filtering and inverse fourier transformation; thresholding, for example to binarise the image; and/or in embodiments, morphological image processing.

In a related aspect the invention provides apparatus for imaging a volume reflection hologram on a surface, said surface bearing said volume reflection hologram and pointing; said hologram and said printing being at least partially co-incident, the apparatus comprising: means for illuminating said surface at a first angle, said first angle being selected such that a first image stored in said volume reflection hologram is replayed; means for capturing a first image of said illuminated surface, said first image comprising an image of said printing and of said first stored image; means for illuminating said surface at a second angle, said second angle being selected such that substantially no image is replayed by said volume reflection hologram; means for capturing a second image of said illuminated surface, said second image comprising an image of said printing substantially without an image stored in said hologram; and means for outputting said first and second image for generating an image of said first stored image from said first image and said second image.

The invention further provides processor control code, in particular on a carrier, for implementing the above described image processing (image generating). Such processor control code may comprise code in any conventional programming language such as C and may include code from a library of image-processing functions; alternatively may comprise code for setting up or controlling an ASIC or FPGA, or hardware description language code. The invention further provides data processing apparatus for the image processing (image generation); this may comprise a conventional general purpose microprocessor or digital signal processor operating in accordance with stored processor control code as described above, or dedicated hardware such as a ASIC, or a combination of the two.

In a further related aspect the invention provides a hologram reader for reading a volume reflection hologram on a surface also bearing printing, the reader comprising:

at least one light source; an optical system coupled to said at least one light source for illuminating said surface at first and second angles, said first angle being different to said second angle; and an image capture device for capturing first and second images of said surface when illuminated at said first and second angles respectively.

Preferably the reader includes a mechanical stop such as spacer, support or optically transparent window against which the surface may be placed to bring the surface into angular alignment thus defining the first and second (or more) illumination angles.

In another aspect the invention provides a security document or bank note comprising:

a substrate bearing printed matter; a volume reflection hologram at least partially disposed over said printed matter.

Preferably the reflection hologram is configured to replay an image at a first wavelength, and the ink has a reflectance peak at a second, different wavelength. The two wavelengths should be machine-resolvable and are preferably spaced by at least the FWHM (full width at half maximum) of one or preferably the wider peak; in embodiments the two different peak wavelengths are distinguishable as the different colours. These colours may comprise complementary colours (colours which mix to produce a predetermined colour, usually white). For example the complementary colours may comprises red and cyan, green and magenta, or blue and yellow, in the C1E 1931 chromaticity diagram complementary colours are opposite one another across the white point; the white point is defined by a standard white illuminant, preferably a D6S illuminant, but optionally a Dso or Illuminant A or Illuminant C illuminant.

Restricting the ink colour can facilitate machine reading of the security document but in embodiments the wavelengths of the image replayed by the hologram and of the ink may be chosen to be visually similar or substantially the same to make counterfeiting harder.

For increased security the volume reflection hologram may store two or more different images configured to replay at different respective wavelengths and/or two or more inks with different peak reflectance wavelengths may be employed, in some preferred embodiments at least one of the images replayed by the hologram includes a biometric image such as an image of a face, fingerprint or iris.

In a variant of the above described techniques the invention provides a method of imaging a hologram on a surface, said surface bearing said hologram and printing, said hologram and said printing being at least partially co-incident, the method comprising: illuminating said surface at a first angle to replay an image stored in said hologram; capturing a first image of said illuminated surface, said first image comprising an image of said printing and of said stored image; illuminating said surface at a second angle to replay said stored image, said second angle being selected such that corresponding portions of said stored image replayed at said first and second angles have different colours; capturing a second image of said illuminated surface, said second image comprising an image of said printing and of said differently coloured stored image; and generating an image of said image stored in said hologram from said first captured image and said second captured image.

This variant also provides apparatus for imaging a hologram on a surface, said surface bearing said hologram and printing, said hologram and said printing being at least partially co-incident, the apparatus comprising: means for illuminating said surface at a first angle to replay an image stored in said hologram; means for capturing a first image of said illuminated surface, said first image comprising an image of said printing and of said stored image; means for illuminating said surface at a second angle to replay said stored image, said second angle being selected such that corresponding portions of said stored image replayed at said first and second angles have different colours; means for capturing a second image of said illuminated surface, said second image comprising an image of said printing and of said differently coloured stored image; and means for generating an image of said image stored in said hologram from said first-captured, image and said second captured image.

These variants are particularly useful for holograms such as embossed holograms in which the replayed images changes colour with angle of illumination, thus allowing the print and holographic images to be separated by their different colours. Where the colours overlap, the images may be substantially separated by subtracting images in the different colour (eg red, green and blue) channels, optionally with an adjustment or compensation for absorption by the hologram. It will be appreciated that in the above describe variant techniques the hologram is configured such that the underlying print image is at least partially visible through the hologram. In the case of an embossed hologram this may be achieved by replacing the conventional silvered base with a base comprising a material chosen to provide a refractive index discontinuity to enhance reflection. An example of a suitable high refractive index material which may be employed to achieve this is zinc selenide, which may be applied in a thin layer to the base of the hologram.

In this specification the skilled person will understand, that references to light and optics include ultraviolet and infrared light/optics.

These and other aspects of the invention will now be further described, by way of example only, with reference to the accompanying figures in which:

FIG. 1 shows a schematic diagram of imaging apparatus according to an embodiment of the present invention;

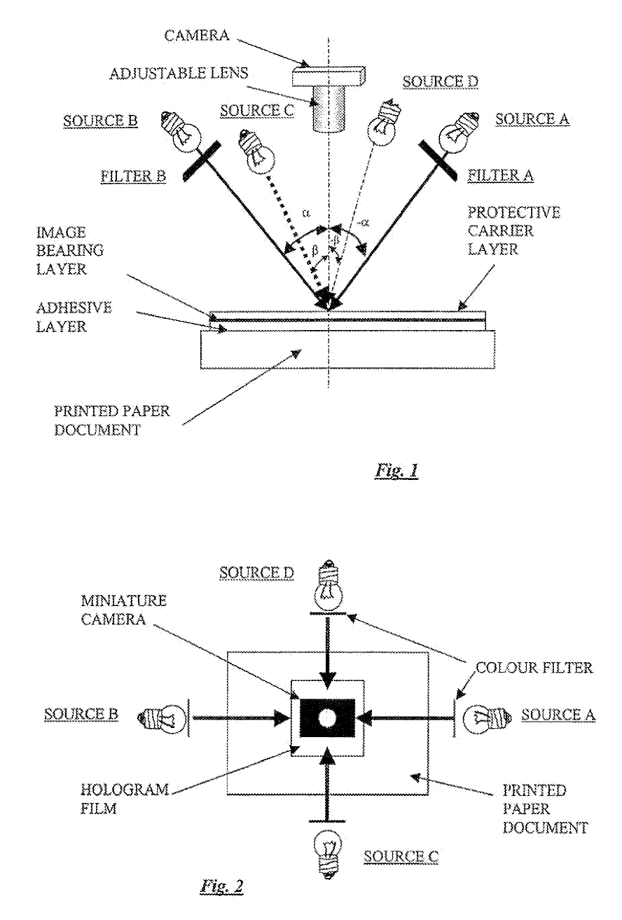

FIG. 2 shows a schematic view from above of the apparatus of FIG. 1;

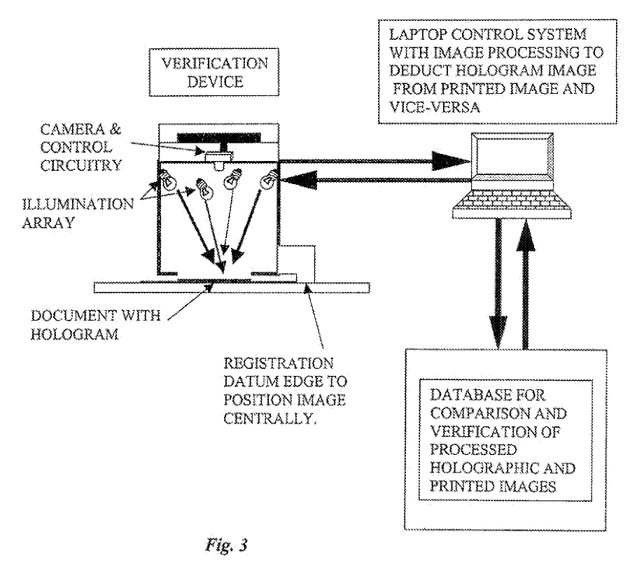

FIG. 3 shows an example of physical configuration of the apparatus of FIG. 1 in which an optical reader is coupled to a laptop computer;

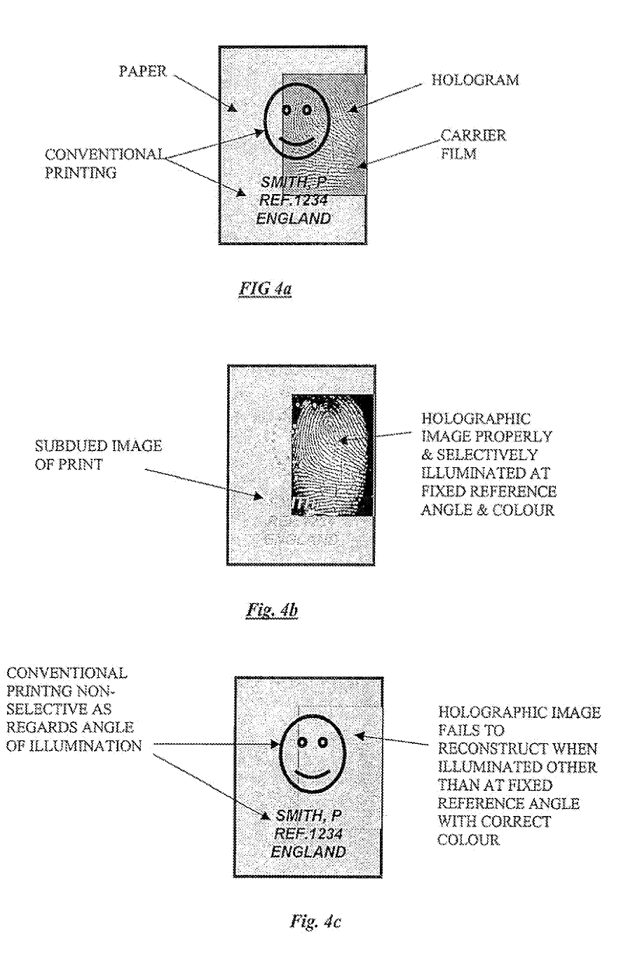

FIGS. 4a, 4b and 4c show, respectively, an example of a security document, incorporating a volume reflection hologram of a biometric image partially overlying printed matter, a first image captured by the apparatus of FIG. 1 including an image replayed by the hologram and print, and a second image captured by the apparatus of FIG. 1 including only the print; and

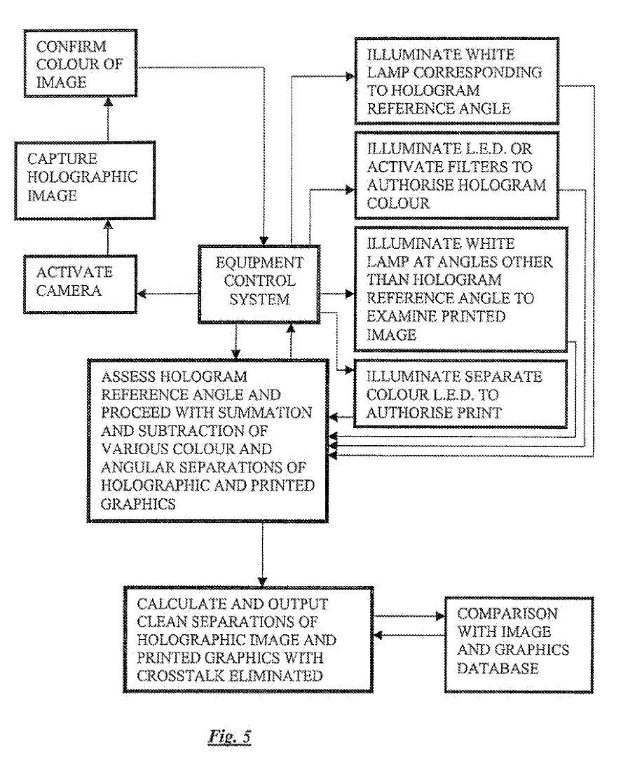

FIG. 5 shows a flow diagram of a computer program stored in the laptop computer of FIG. 1, for implementing an embodiment of the method according to an aspect of the invention.

FIG. 1 shows a schematic of an illumination system and camera set-up used to interrogate a hologram protected security document.

A series of incandescent lamps with adjustable filters or L.E.D. sources are positioned to provide a range of possible angles and colour of illumination towards the security document laminated with a transparent hologram film layer. This transparent layer could comprise an almost colourless layer or be tinted with colour.

With angles of +α and −α on either side of a normal to the plane of the security document and angles of +β and −β on either side of the normal in a perpendicular plane we have a range of four possible directions from which we may select to organise reference reconstruction beams in the hologram.

The skilled holographer will realise that, in other configurations of the device, there is an opportunity also to produce holograms with non-orthogonal reconstruction requirements which considerably increase the complexity of the task of duplication of the holographic label as far as the prospective counterfeit is concerned, since he must predict both axial and azimuthal angles in whilst additionally predicting colour effects and fringe shrinkage which tend to have significant effects on the reconstruction characteristics of the holographic image.

In a preferred embodiment, a miniature (digital) camera is focussed axially upon the document from above. In some instances, the whole device can be configured in an inverted form so that the document is laid face down upon a window, which defines the plane of focus of the camera. Furthermore, a ‘swipe’ mechanism may be utilised in applications where a 1-dimensional security coding, such as a barcode, is the subject of the hologram.

The holographic image could be for example, a biometric such as a fingerprint, iris scan, a facial portrait, or some other unique data store such as a barcode recording.

The camera in one embodiment may have variable focal plane in order to enable precise focus to holographic features, which are displaced from the surface of the film by utilising the three-dimensional recording capabilities of a hologram, and also permit sharp focus upon the printed document surface to allow accurate analysis of the printed image.

Such separation of the focal plane of the holographic image from the plane of the printing facilitates improved ability to avoid ‘cross talk’ between the two separate images to be interrogated by the reader device.

Preferably, the orientation of the document itself will indicate the direction of illumination required by the reader to illuminate the hologram and reconstruct its image. Alternatively, in a more complex automated embodiment, it may be necessary for the software to conduct a search for the image by consecutive illumination from the various available sources, whilst the camera system seeks an image of the expected format.

In the preferred embodiment, the illumination of the hologram from the correct direction and reference angle will allow the device to provide a single illumination wavelength compatible with the specified colour of the security hologram. The absence of the correct coloration of the hologram will immediately reveal a non-genuine device. Further, it is also difficult, for a counterfeiter to simulate the precise angle of reference of a volume hologram at a specific colour. As a result the position of the light sources within the reader described in this document, will inhibit the counterfeiter from achieving sufficient brightness in the reconstructed image unless precise simulation of the exact reference angle and direction has occurred.

FIG. 2 shows a plan view of the configuration of the optical components to explain the angular distribution of the available light sources relative to the axially placed camera, and FIG. 3 shows the physical embodiment of the reader device.

The device comprises in its base plate, adjustable position guide edges against which any type of security document can be held in such a way that its printed and holographic imagery is quickly and reliably placed in a favourable position to allow the camera a central view of the hologram and the underlying printing, which could be, for example, text, or a portrait photograph. Such a photographic portrait in a security document could configured from the same graphics files, or could derive from a completely separate image. Equally, it may be another form of biometric which could be related or unconnected with the holographic image.

Preferably the software does not require that the images should be in a registered position provided they are reasonably central to the camera viewing window. The software searches within the recorded image for the characteristic feature required for comparison with a live scan or database entry.

FIG. 3 also shows that the reader system is enveloped in a dark enclosure to eliminate ambient light from the camera lens. The control electronics is housed within the closed unit, and all of the light sources, filters, and camera controls are operated by a laptop computer, or similar software-based control system, and the reader may be either a portable or permanently fixed device. In applications where such a dark enclosure is not possible, the principles of ‘chopped’ light with synchronisation of the camera detectors may be used (modulation, with a lock-in amplifier).

The use of Light Emitting Diodes (LED's) as light sources requires low power consumption but provides monochromatic sources in a plurality of wavelengths and enables the sources to be positioned in tight clusters so as to provide illumination in a number of colours from a single direction corresponding to the directional requirements of volume holograms. In some cases, it is possible to use LED's with alternating colour. For example LED's which respond to alternating polarity in their power supply produce alternating colours as a result.

An LED, which provides red and green light in cyclic fashion, may be synchronised with a camera system directly, or by the use of a separate mechanical or electronic SLM (Spatial Light Modulator). A particularly compact device can be built in this embodiment of the method, and it may be possible to provide adequate security in this configuration by the use of only two colours for hologram and print interrogation.

Alternatively, incandescent lamps may be used in conjunction with narrow bandpass filters which transmit a single wavelength of light and which may be incorporated in a colour wheel, which is computer controlled, and may retain stationary status or may rotate to provide alternating colour incident upon the hologram or print as previously described.

Optionally means may be provided to determine a brightness or diffraction efficiency of the hologram. For example, some of the light from the LED's or lamps may be intercepted by a separate detector in order to provide an assessment of the energy in the reference beam to the hologram or printed image in order to provide a barrier to the substitution of an inferior or counterfeit image, which may often differ radically in brightness or efficiency.

FIG. 3 shows that the verification device itself is in two-way communication with the control computer, which may be a laptop or a larger or more powerful computer.

Similarly the control computer may be in two-way communication with a network or separate remote database computer.

FIG. 4 shows the type of image seen by the camera and data relayed to the computer, via the electronic circuitry in the reader device.

FIG. 4a shows the appearance expected from the overlaid security document in ordinary ambient diffuse light. The hologram layer covers all or part of the printed image and may be loosely or precisely registered in its position or may be offset as shown in the diagram. The visual observer can make considerable use of the security document and visual interrogation may be a meaningful examination when a reader system is not available, for example in an emergency such as a power-cut, or in a remote foreign environment. Under these conditions for example, a biometric e.g. fingerprint expert, may be able to retrieve a great deal of security information from the combined document. Additionally an trained observer may be able to make useful observations about the printing technology or the holographic image such as their colour quality.

Preferably, however the device described is used to make a complex analysis of the combined images as shown in FIG. 4b and 4c.

FIG. 4b demonstrates lighting conditions within the illumination system which enable the camera system to provide the software with definitive data related to the holographic information shown here as a fingerprint biometric. Here the system has located the correct reference angle to reconstruct the holographic image. The colour of the illumination can by changed by the control system to establish that the holographic image is of the correct colour as required to prove one aspect of its authenticity.

Preferably the control system is configured to illuminate the document (or other substrate) from each of a plurality of positions to detect the hologram. If the control system begins with white illumination from the four position stations designated A,B,C, and D in FIG. 2, then at least one of these will result in a significantly higher level of illumination at the hologram is illuminated. At the stations where no reconstruction of holographic image results, the printed image on the document will reflect light but this will be predominantly highly diffuse and non-directional as far as the direction of illumination is concerned.

For example with white light illumination from four directions A,B,C,D the typical values of the pixel matrix illumination for each of the white lamps or simultaneous group of LED's calculable at the computer could be

### WHITE ‘A’=100

### WHITE ‘B’=20

### WHITE ‘C’=100

### WHITE ‘D’=20

We can conclude that the hologram illuminates at lamps A and C but fails to illuminate by B and D. The illumination due to printed image will be predominantly similar from ail positions. However, when the hologram reflects fight towards the camera in a single wavelength from A and C there will be only residual light transmitted to printed image and thus its contribution to the total reflection will be slightly lower at a single wavelength only. Say,
Illum_{red}=R
Illum_{green}=G
Illum_{blue}=B

Then, for example, if reflected light from position A
WHITE ‘A’=100 units
Then 100=R+G+B

Switching to individual Red, Green and Blue wavelength illumination from the same position ‘A’ now the reflectivity seen at the camera is, for example:

$$R = 60 ( 45 red from hologram + 15 red from printed image )$$

$$G = 30 ( 30 green from printed image )$$

$$B = 10 ( 10 blue from printed image )$$

$$…$$

$$Total = 100$$

The system, now deduces that the hologram is red,

From a second position B however the hologram does not illuminate, but reflection from the printed Artwork as shown in FIG. 4b is the dominant effect. Here the hologram foil is almost insignificant. However the printed artwork may have colours of its own, and thus the reflection seen can be quantified in individual colours without significant deduction of light reflected from the holographic layer.

R=20 (more light arrives at the print when hologram reconstruction is eliminated)

### G=30

### B=10

The simultaneous equations of total light reflected enable the computer to calculate that the conventional printing reflects proportions of red, green and blue light and predominantly green.

The algorithm preferably takes into account that the printed ink is working in a subtractive colour system (e.g. CMYK) whereas the hologram works in an additive colour system (e.g RGB). To obtain the holographic image the green and blue channels may be subtracted off and the red channel print image may, for example, be subtracted after adjusting for absorption by the hologram, for example by multiplying by a factor close to but less than unity. Very accurate correction is possible if the software takes into account absorbance, diffusion,, reflection, surface reflection.

Thus the inclusion of a multi-colour hologram results in additional totals of reflection, whereas a higher density of multicolour or black and white printing results in a reduction the total level of reflection.

The device is thus able to assign the individual levels of reflection to the individual image components (e.g. print and hologram) and thus upon a per pixel basis is able to separate the individual component images associated with or within the document surface.

FIG. 5 shows a flow diagram of operations of the system. The operation of the camera with white illumination is seen to determine the angle of illumination of the holographic image. There may be more than one angle of illumination.

Monochromatic illumination in a plurality of colours then enables the device to establish the shape and colour of the holographic image, it may contain more than one colour.

It is then possible to illuminate the document with a range of colours from positions which will not reconstruct the holographic image and thus establish the shape and colour of the printed image.

The software, is able to separate the bitmaps associated with the individual component images.

No doubt many other effective alternatives will occur to the skilled person. For example although the invention has been described with specific reference to volume reflection of holograms similar techniques may be used with other types of hologram, in particular (as described above) holograms where the colour changes with the angle of illumination, thus enabling a replayed holographic image to be distinguished from an image of printed or other material which does not change substantially with angle of illumination. One example is embossed holograms, preferably on a (non-silvered) high refractive index base to enhance interface reflectivity, for example, employing zinc selenide.

Similarly although embodiments of the invention have been described for use with holograms which overlay print actually the same techniques may be employed where a hologram does not coincide with print but is merely in the same vicinity of the print on the surface of the security document or bank note.

The invention is not limited to the described embodiments but encompasses modifications apparent to those skilled in the art lying within the spirit and scope of the claims appended hereto.

1-27. (canceled)

28. A method of imaging a volume reflection hologram on a surface, said surface bearing said volume reflection hologram and printing, said hologram and said printing being at least partially co-incident, the method comprising:
illuminating said surface at a first angle, said first angle being selected such that a first image stored in said volume reflection hologram is replayed;
capturing a first image of said illuminated surface, said first image comprising an image of said printing and of said first stored image;
illuminating said surface at a second angle, said second angle being selected such that substantially no image is replayed by said volume reflection hologram;
capturing a second image of said illuminated surface, said second image comprising an image of said printing substantially without an image stored in said hologram; and
generating an image of said first image stored in said hologram from said first captured image and said second captured image.

29. A method as claimed in claim 28 wherein said illuminating at said first angle comprises illuminating at a first wavelength, said first wavelength being selected to replay said first stored image from said volume reflection hologram, and wherein said illuminating at said second angle comprises illuminating at one or more second wavelengths, said one or more second wavelengths being selected to substantially inhibit replay of said first stored image by said hologram.

30. A method as claimed in claim 28 wherein said first and second angle of illumination make substantially the same angle with a normal to said surface.

31. A method as claimed in claim 30 wherein said first and second angle of illumination are substantially oppositely disposed about said normal to said surface.

32. A method as claimed in claim 28 wherein said volume reflection hologram stores a second image, the method further comprising:
illuminating said surface at a third angle, said third angle being selected such that said second stored image is replayed;
capturing a third image of said illuminated surface, said third image comprising an image of said printing and of said second stored image; and
generating an image of said second image stored in said hologram from said first captured image and said third captured image.

33. A method as claimed in claim 32 wherein said illuminating at said third angle comprises illuminating at a third wavelength, said third wavelength being selected to replay said second image stored in said hologram.

34. A method as claimed in claim 28 wherein said image generating comprises a non-linear operation.

35. Apparatus for imaging a volume reflection hologram on a surface, said surface bearing said volume reflection hologram and printing, said hologram and said printing being at least partially co-incident, the apparatus comprising:
means for illuminating said surface at a first angle, said first angle being selected such that a first image stored in said volume reflection hologram is replayed;
means for capturing a first image of said illuminated surface, said first image comprising an image of said printing and of said first stored image;
means for illuminating said surface at a second angle, said second angle being selected such that substantially no image is replayed by said volume reflection hologram;
means for capturing a second image of said illuminated surface, said second image comprising an image of said printing substantially without an image stored in said hologram; and
means for outputting said first and second image for generating an image of said first image stored in said hologram from said first captured image and said second captured image.

36. A carrier medium carrying processor control code for said generating of an image of said first image stored in said hologram from said first captured image and said second captured image as claimed in claim 28.

37. Computer apparatus including the carrier medium of claim 35.

38. A hologram reader for reading a volume reflection hologram on a surface also bearing printing, the reader comprising:
at least one light source;
an optical system coupled to said at least one light source for illuminating said surface at first and second angles, said first angle being different to said second angle; and
an image capture device for capturing first and second images of said surface when illuminated at said first and second angles respectively.

39. A hologram reader as claimed in claim 38 configured to illuminate said surface at said first angle with a light of a first wavelength and to illuminate said surface at said second angle with a different wavelength different to said first wavelength.

40. A hologram reader as claimed in claim 39 comprising at least two light sources, a first light source to illuminate said surface at said first angle with the light of a first wavelength, and a second light source to illuminate said surface at said second angle with a different wavelength different to said first wavelength.

41. A hologram reader as claimed in claim 38 further comprising a mechanical stop for bringing said surface and said optical system into an angular alignment, and wherein said optical system is configured such that said first and second angles of illumination make substantially the same angle with a normal to said surface defined by said angular alignment.

42. A hologram reader as claimed in claim 41 wherein said first and second angles of illumination are substantially oppositely disposed about said normal to said surface defined by said angular alignment.

43. A hologram reader as claimed in claim 38 wherein said first image comprises an image of said printing and an image replayed by said hologram wherein said second image comprises an image of said printing from which said image replayed by said hologram is substantially inhibited; and further comprising an image processing system configured to generate an image of said replayed hologram from said first and second images.

44. A hologram reader as claimed in claim 39 wherein said image processing system is further configured to compare said replayed image with a reference image to determine whether said replayed and reference images match.

45. A security document or bank note comprising:
a substrate bearing printed matter;
a volume reflection hologram at least partially disposed over said printed matter.

46. A security document as claimed in claim 41 wherein said volume reflection hologram is configured to replay an image at a first wavelength, and wherein said printed matter has a reflection peak at a second wavelength different to and resolvable from said first wavelength.

47. A security document as claimed in claim 41 wherein said first wavelength and said second wavelength define visually different colours to a human observer.

48. A security document as claimed in claim 42 wherein said first wavelength and said second wavelength define complementary colours.

49. A security document as claimed in claim 48 wherein said printed matter comprises inks of two different peak reflectance wavelengths, each different from said first wavelength of said replayed image of said hologram.

50. A security document as claimed in claim 48 wherein said volume reflection hologram is configured to replay two different images at different respective wavelengths of illumination.

51. A security document as claimed in claim 48 wherein a said replayed image comprises a biometric image, in particular a fingerprint.

52. A method of imaging a hologram on a surface, said surface bearing said hologram and printing, said hologram and said printing being at least partially co-incident, the method comprising:
illuminating said surface at a first angle to replay an image stored in said hologram;
capturing a first image of said illuminated surface, said first image comprising an image of said printing and of said stored image;
illuminating said surface at a second angle to replay said stored image, said second angle being selected such that corresponding portions of said stored image replayed at said first and second angles have different colours;
capturing a second image of said illuminated surface, said second image comprising an image of said printing and of said differently coloured stored image; and
generating an image of said image stored in said hologram from said first captured image and said second captured image.

53. A carrier medium carrying processor control code for said generating of an image of said image stored in said hologram from said first captured image and said second captured image as claimed in claim 52.

54. Apparatus for imaging a hologram on a surface, said surface bearing said hologram and printing, said hologram and said printing being at least partially co-incident, the apparatus comprising:
means for illuminating said surface at a first angle to replay an image stored in said hologram;
means for capturing a first image of said illuminated surface, said first image comprising an image of said printing and of said stored image;
means for illuminating said surface at a second angle to replay said stored image, said second angle being selected such that corresponding portions of said stored image replayed at said first and second angles have different colours;
means for capturing a second image of said illuminated surface, said second image comprising an image of said printing and of said differently coloured stored image; and
means for generating an image of said image stored in said hologram from said first captured image and said second captured image.
